(19) United States
(12) Patent Application Publication
(10) Pub. No.: US 2009/0279540 A1
(43) Pub. Date: Nov. 12, 2009

(54) CLUSTER COUPLER IN A TIME TRIGGERED NETWORK

(75) Inventor: Andries Van Wageningen, Wijlre (NL)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/440,450

(22) PCT Filed: Aug. 27, 2007
(86) PCT No.: PCT/IB07/53414

§ 371 Date: Mar. 6, 2009

(30) Foreign Application Priority Data
Sep. 6, 2006 (EP) 06120217.2

(51) Int. Cl. H04L 12/50

(52) U.S. Cl. 370/375

(57) ABSTRACT

The invention relates to a cluster coupler in a time triggered network for connecting clusters operating on the same protocol. Further, it relates to a network having a plurality of clusters, which are coupled via a cluster coupler. It also relates to a method for communicating between different clusters. To provide a cluster coupling means, a network and a method for communicating between clusters which are able to couple a plurality of clusters operating on the same time triggered protocol to achieve a selectively forwarding of data without message buffering or frame delay a cluster coupler in a network is proposed operating on a time triggered protocol using time slots, wherein the cluster coupler (10) is coupled to at least two clusters (A, B, X), a cluster includes at least one node (11), wherein the same protocol is used within the clusters, the cluster coupler (10) comprises: as many protocol engines (12) as clusters are connected, a switch (20), a switch control unit (21); wherein a protocol engine (12) is transmitting and receiving data in time slots from the cluster (A, B, X) and generating control information based on the cluster communication schedule of the connected cluster (A-X) for configuring the switch (20).

The invention relates to a cluster coupler in a time triggered network for connecting clusters operating on the same protocol. Further, it relates to a network having a plurality of clusters, which are coupled via a cluster coupler. It also relates to a method for communicating between different clusters.

Dependable automotive communication networks rely on time triggered communication protocols like TTP/C or FlexRay, based on broadcast methods according to predetermined TDMA scheme. Time-triggered protocols are proposed for distributing real-time communication systems as used in, for example the automobile industry. Communication protocols of this kinds are described in “FlexRay—A Communication System for advanced automotive Control Systems” SEA World Congress 2001. In these systems, the media access protocol is based on a time triggered multiplex method, such as TDMA (Time Divisional Multiplex Access) with a static communication schedule, which is defined in advance during system design. This communication schedule defines for each communication node the times at which it may transmit data within a communication cycle.

Such network may include a plurality of different communication clusters. Each cluster includes at least one node. A plurality of nodes within a cluster may be interconnected by various topologies. Star couplers are normally applied to increase a number of nodes within a cluster, wherein gateways are used to interconnect the clusters.

The separation of nodes into clusters or domains is a well-known solution to handle different application domains in parallel. That means, nodes or applications within the same cluster may communicate, wherein other applications running on nodes in other clusters may communicate in parallel. However, if a data exchange between applications running on different nodes within different clusters is required additional exchange of data between clusters will be necessary. Because existing domains have been evolved separately over time without a need for tight interaction, they are locally optimized and served with mostly different communication protocols. Therefore, current networks are highly heterogeneous and can only be connected by use of gateways serving different protocol stacks. The heterogeneous character of a network will result in hard limitations of inter domain communication in respect to the delay, jitter and fault tolerance.

A first solution to overcome this limitation due to the delay, jitter and fault tolerance maybe to use a single protocol, preferably one protocol meeting higher requirements, i.e. FlexRay protocol, which maybe applied for different clusters to realize a more homogeneous network and to thereby interconnect the clusters more tightly and offer a better end-to-end performance in respect to delay, jitter and fault tolerance. This will give the system designer more flexibility for system partitioning, because closely related functions running on different nodes do not necessarily have to be mapped to nodes allocated in the same cluster. This decreases the number of nodes within a cluster thereby reducing the required bandwidth and the probability of faults per cluster and improving the fault protection by separation of smaller application domains into more clusters.

Conventionally gateways are used for connecting clusters. In general, a gateway may add significant delay and jitter in the end-to-end data path, because it includes a communication protocol stack for each connected cluster. It also contributes to the probability of faults to the end-to-end path.

It is therefore an object of the present invention to provide a cluster coupling means, a network and a method for communicating between clusters which are able to couple a plurality of clusters operating on the same time triggered protocol to achieve a selectively forwarding of data without message buffering or frame delay.

The object is achieved by the features of the independent claims.

According to the invention, a cluster coupler includes as many protocol engines as clusters are connected to the cluster coupler. A prerequisite for an inventive cluster coupler is that the connected clusters operate on the same time-triggered protocol using time slots. Further, the inventive cluster coupler includes a switch having a plurality of input ports and output ports. The switch is connected to the protocol engines and to the cluster ports in the cluster coupler. Further, there is a switch control unit, which receives control information and/or startup/synchronization information from the protocol engines and controls the switch respectively. These protocol engines are transmitting and receiving data in time slots from the connected clusters and generating there from control information and/or startup/synchronization information for configuring the switch. Thus, it is possible to selectively forward data between the connected clusters without intermediate message buffering. The inventive cluster coupler applies a buffer-less switch connecting the clusters and the protocol engines. Thus, the switch can be utilized to forward data between each protocol engine and its cluster, to forward data between the connected clusters and to forward date between the protocol engines. A further prerequisite is that the clusters need to be configured alike so that the cycle length and the time slot length and frame length are compatible to each other.

The invention is based on the thought to interconnect the clusters by use of the cluster coupler, wherein the interconnection which cluster is to be connected to another cluster is based on information stored in a cluster communication schedule of each protocol engine. At startup and during operation the protocol engines synchronize the clusters. The configuration of a switch is controlled on a time slot basis. Thus, by controlling the switch depending on control and startup/synchronization information provided by the protocol engines, it is possible to intelligent connect the dataflow between clusters and between protocol engines or between protocol engines and clusters without providing any buffer means in the cluster coupler. The switch configuration maybe changed for each time slot.

Further, advantageous implementations and embodiments of the invention are set forth in the respective sub claims.

The invention provides the advantage that the clusters could be easily synchronized via the switch. Further, by controlling the switch in dependency of the cluster communication schedules a protection functionality is achieved. Thus, the switch is only forwarding data if one of protocol engines of the cluster coupler is instructing the switch to do so. Therefore, so called babbling idiots nodes within a cluster may be easily blocked. Additionally, the propagation of faults into other clusters may be prevented by controlling the switch according to the invention.

The invention is described in the detail below as referenced in the accompanying schematic drawings, wherein it is illustrated in:

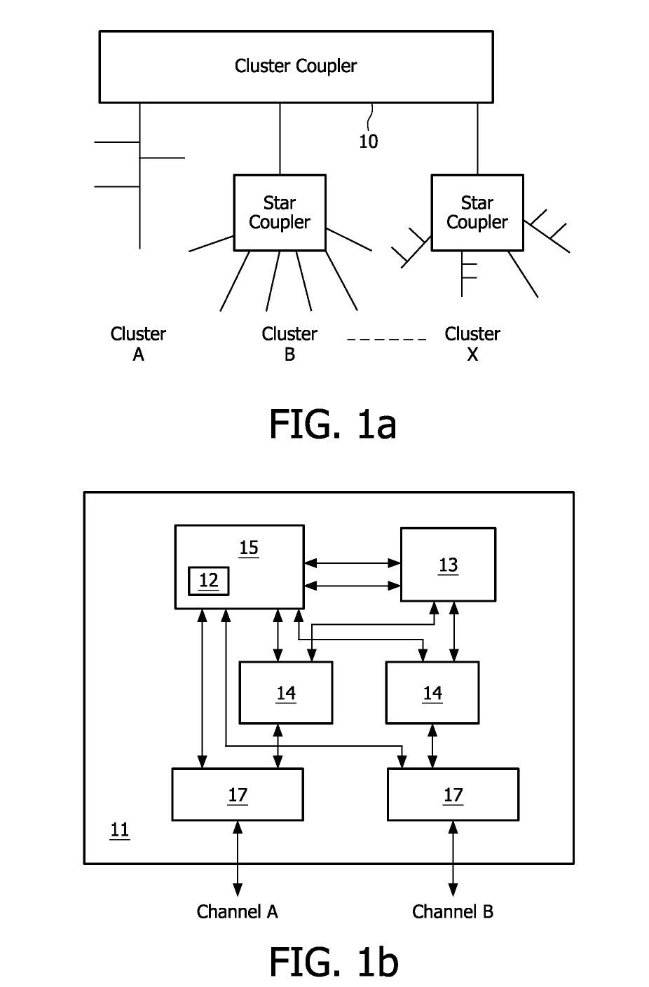

FIG. 1a a network including a plurality of clusters;

FIG. 1b a schematic block diagram of a node;

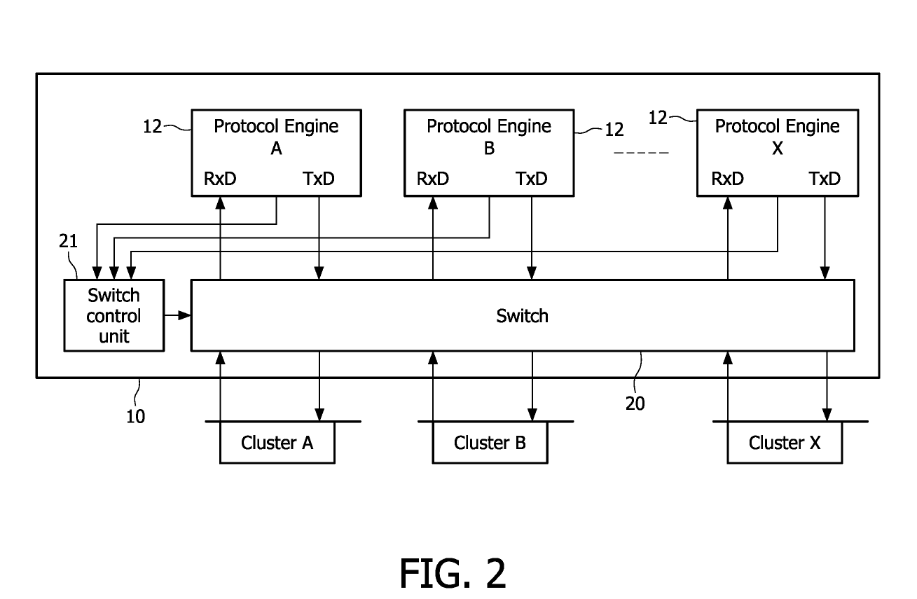

FIG. 2 a configuration of a cluster coupler according to the invention;

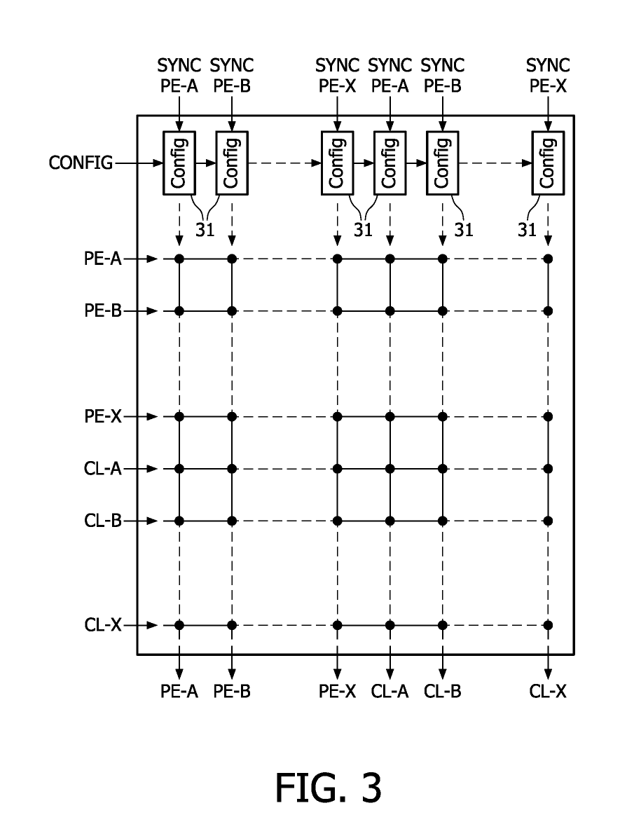

FIG. 3 a cross-point matrix according to the invention;

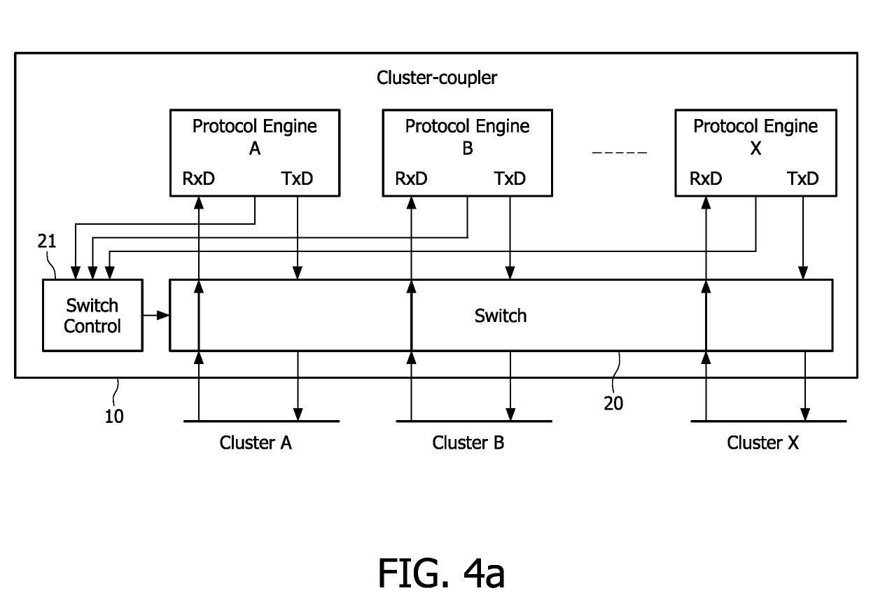

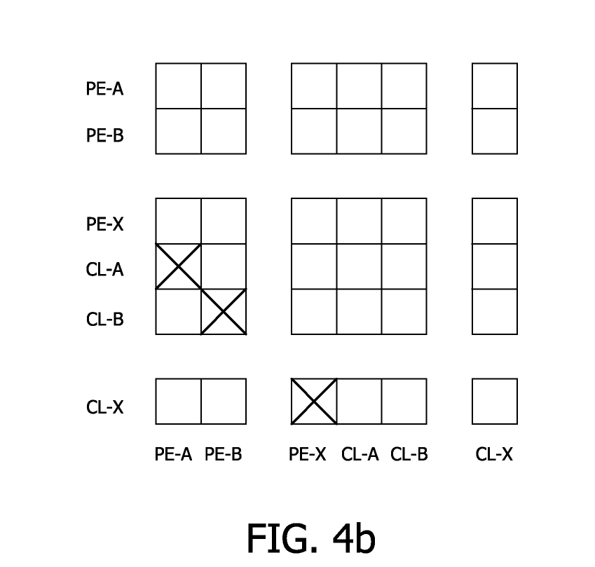

FIG. 4a a cluster coupler in a first state according to the invention;

FIG. 4b a configuration matrix for a cluster coupler according to 4a;

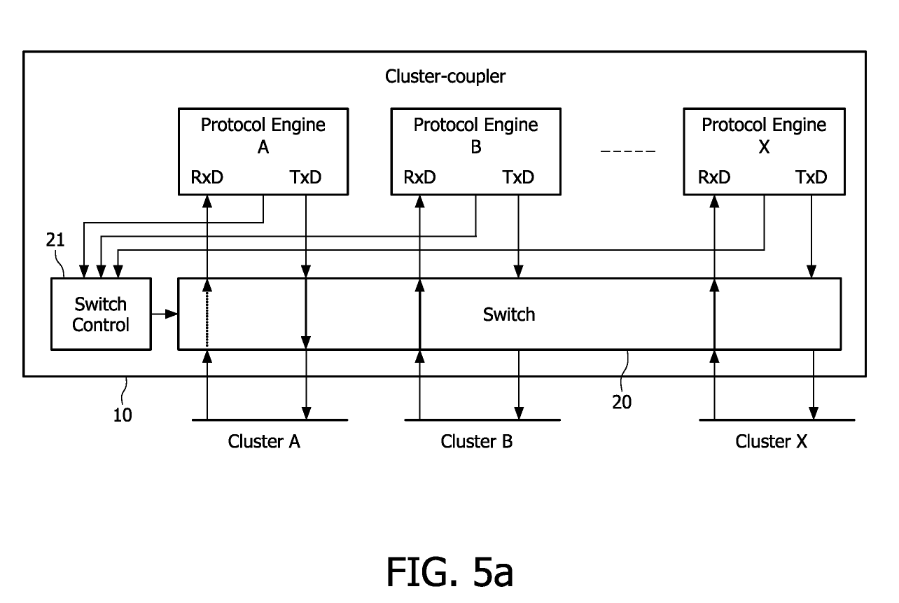

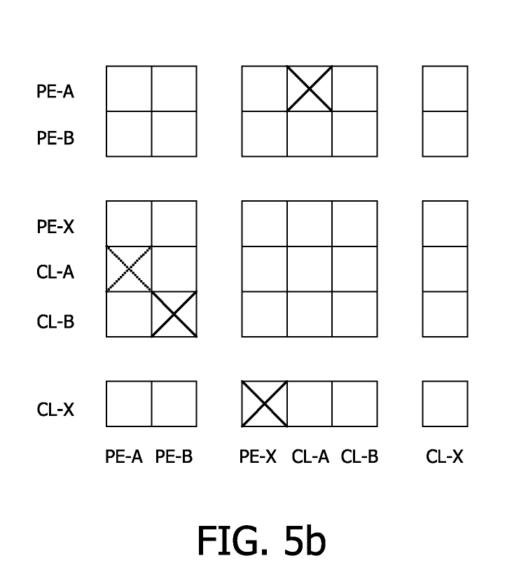

FIG. 5a a cluster coupler in a further state;

FIG. 5b a configuration matrix for a cluster coupler according to FIG. 5a;

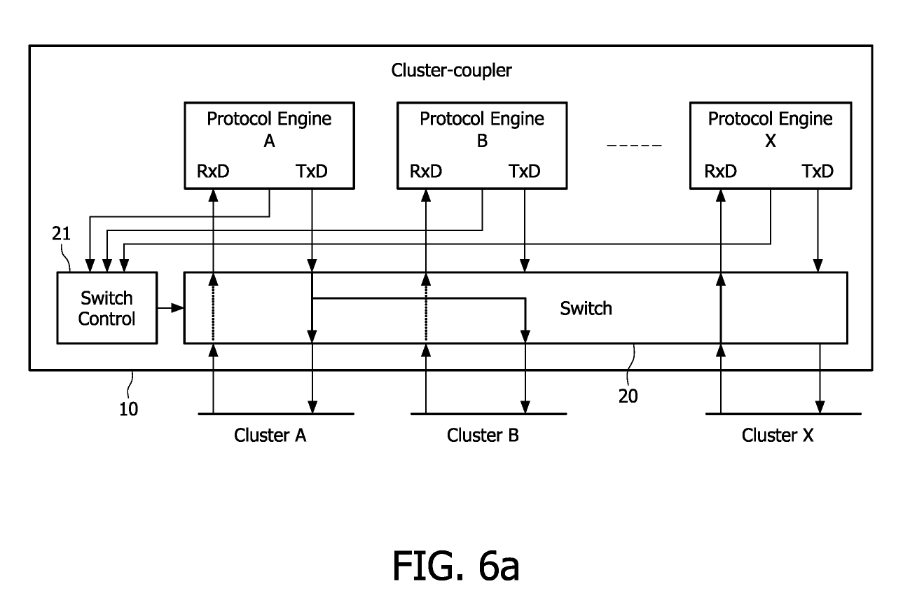

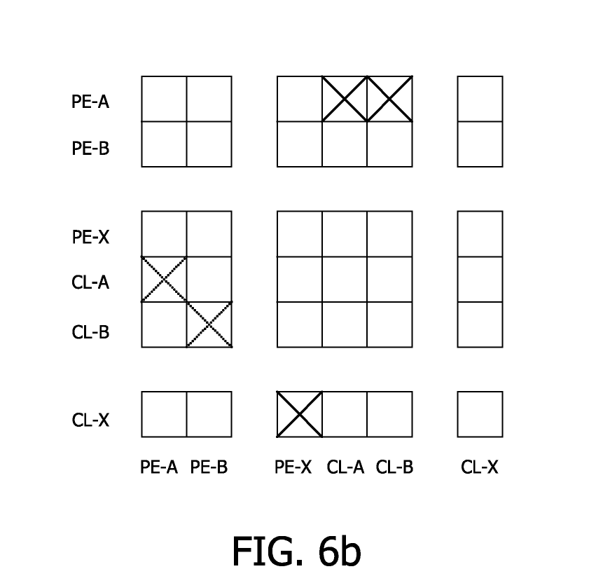

FIG. 6a a cluster coupler in a further state;

FIG. 6b a configuration matrix for a cluster coupler according FIG. 6a;

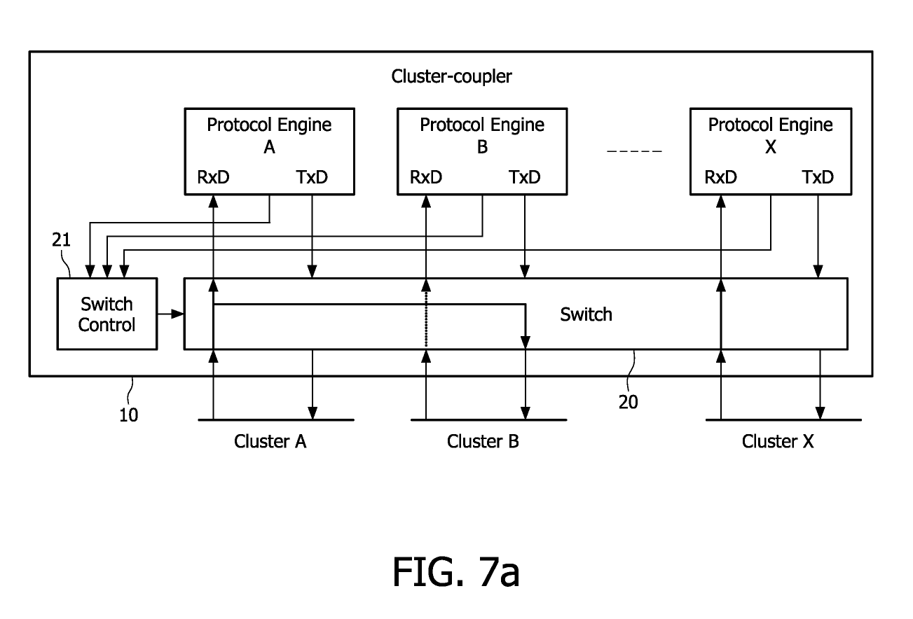

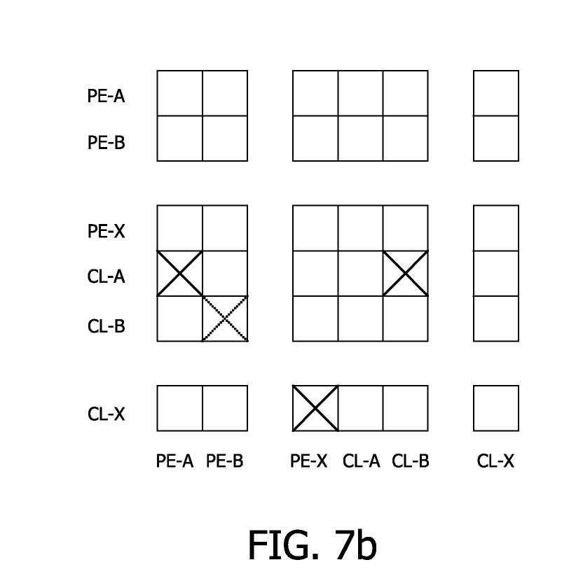

FIG. 7a a cluster coupler in a further state;

FIG. 7b a configuration matrix for a cluster coupler according FIG. 7a;

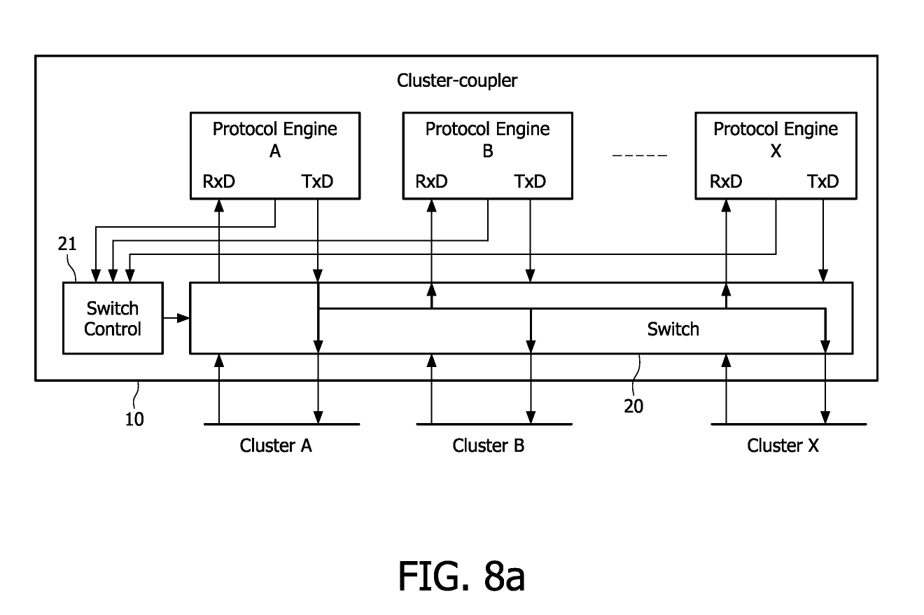

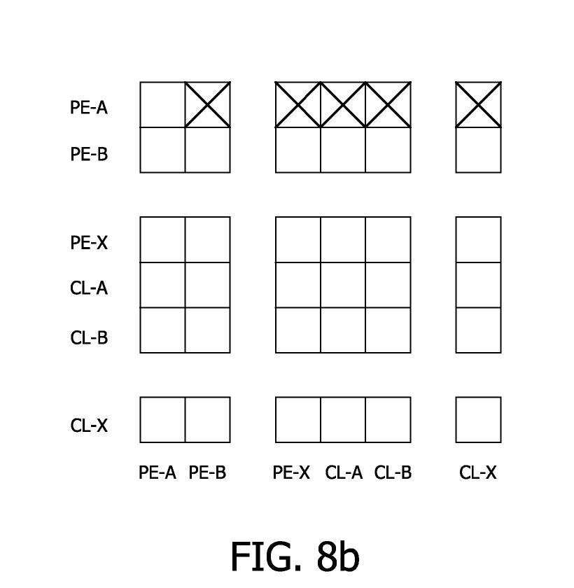

FIG. 8a a cluster coupler in a further state;

FIG. 8b a configuration matrix for a cluster coupler according FIG. 8a;

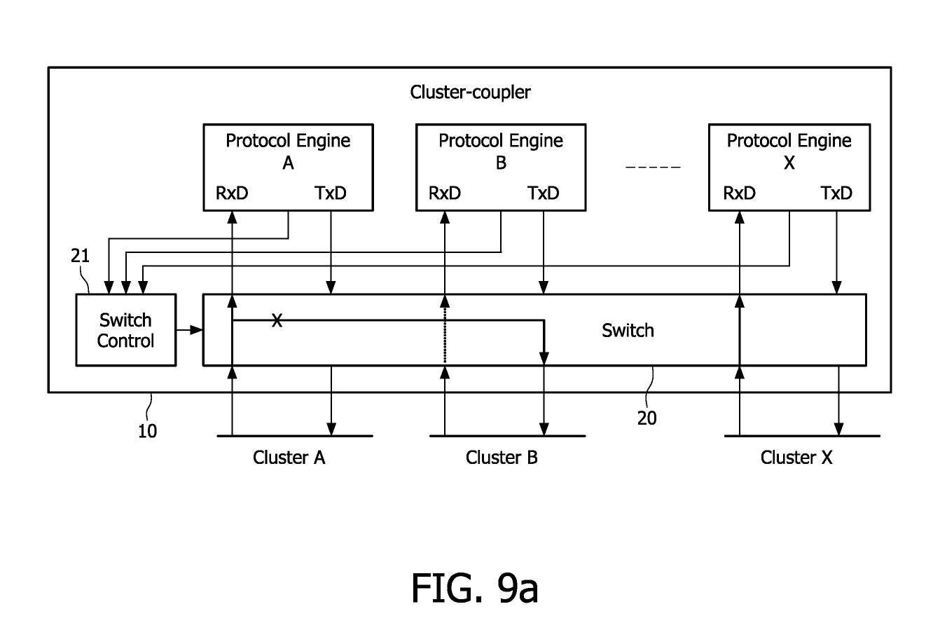

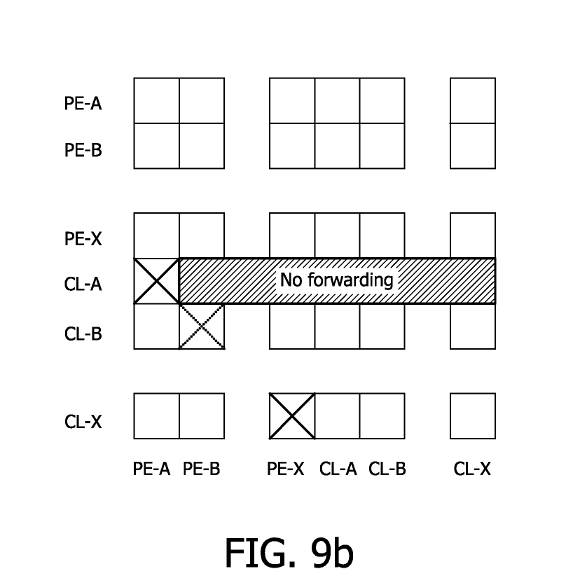

FIG. 9a a cluster coupler in a further state;

FIG. 9b a configuration matrix for a cluster coupler according FIG. 9a;

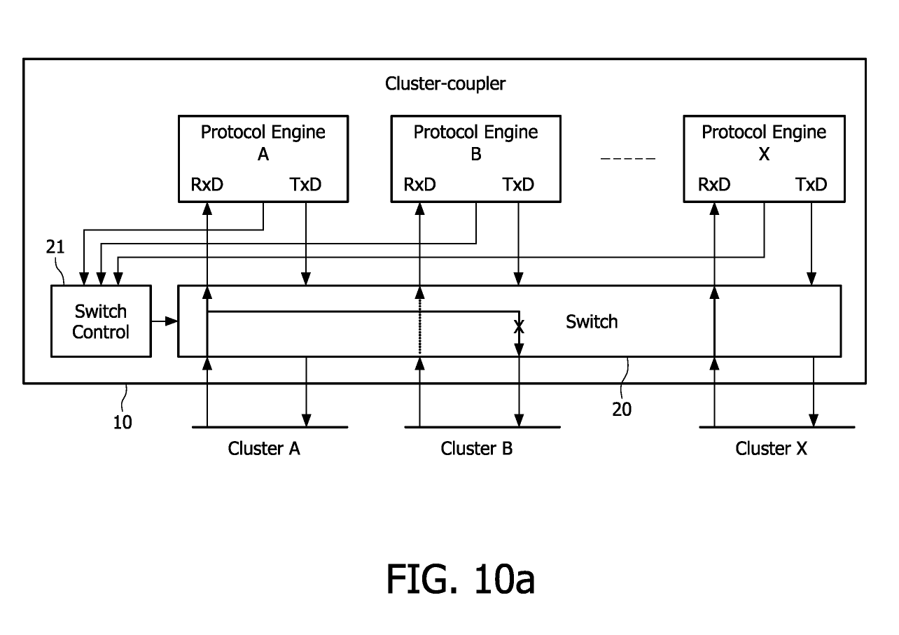

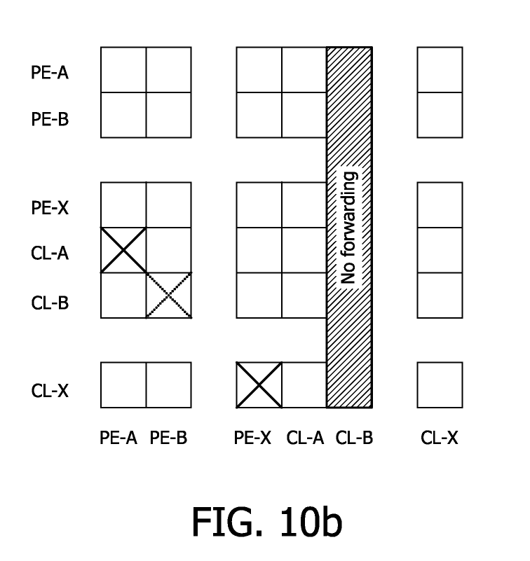

FIG. 10a a cluster coupler in a further state;

FIG. 10b a configuration matrix for a cluster coupler according FIG. 10a;

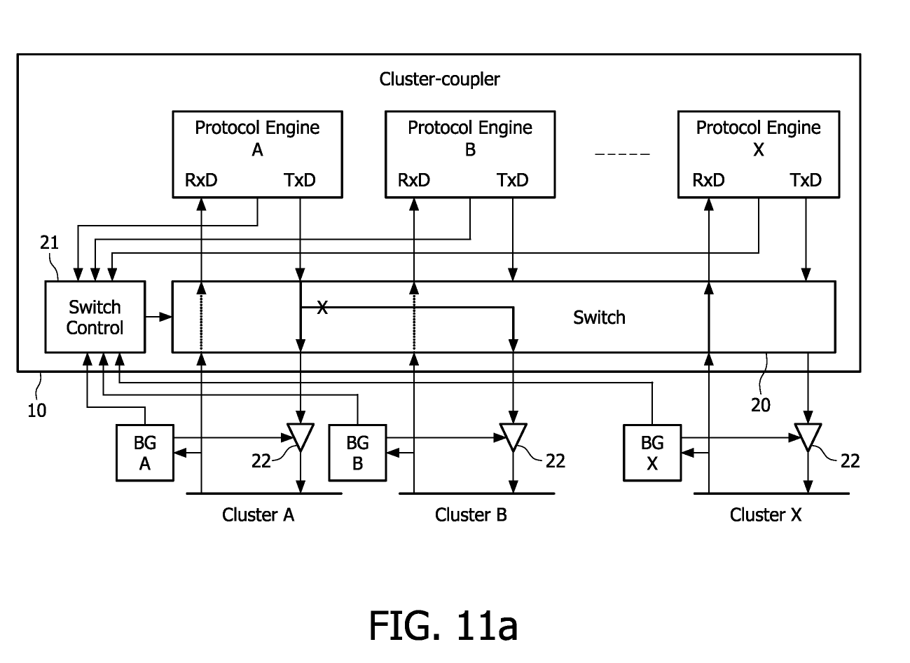

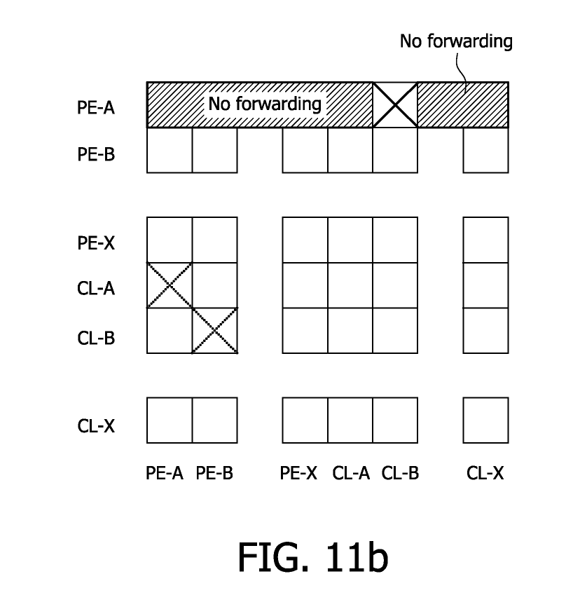

FIG. 11a a cluster coupler in a further state;

FIG. 11b a configuration matrix for a cluster coupler according FIG. 11a;

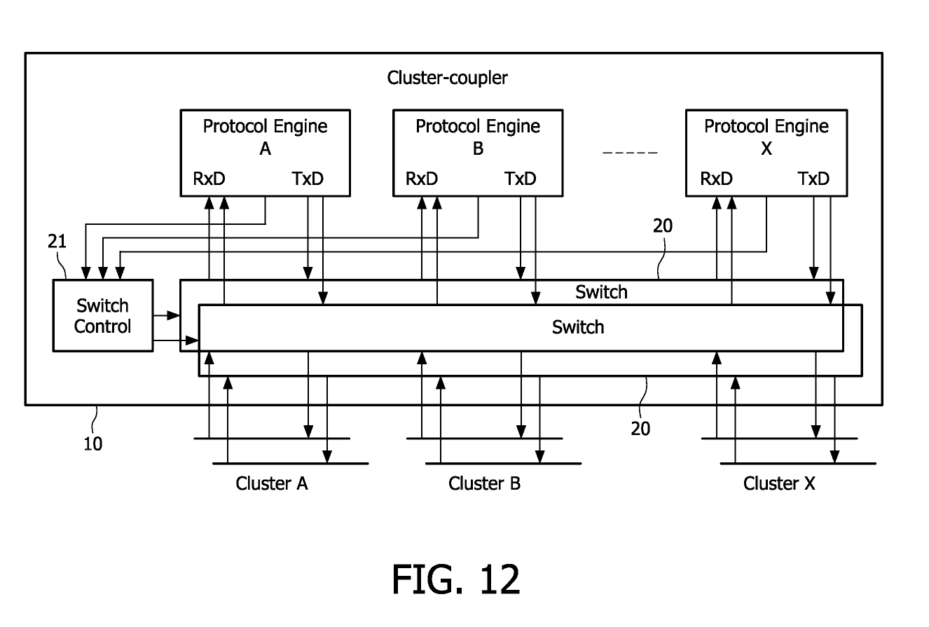

FIG. 12 a further embodiment of an cluster coupler according to the invention;

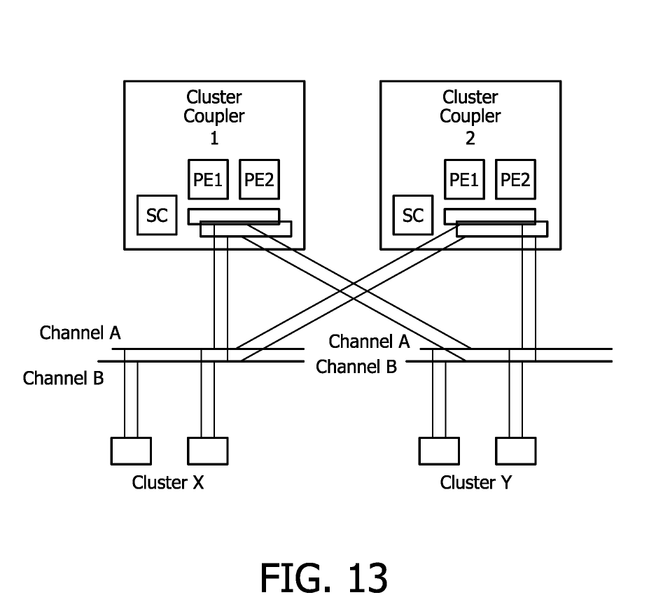

FIG. 13 an embodiment for connecting a cluster coupler as shown in FIG. 12;

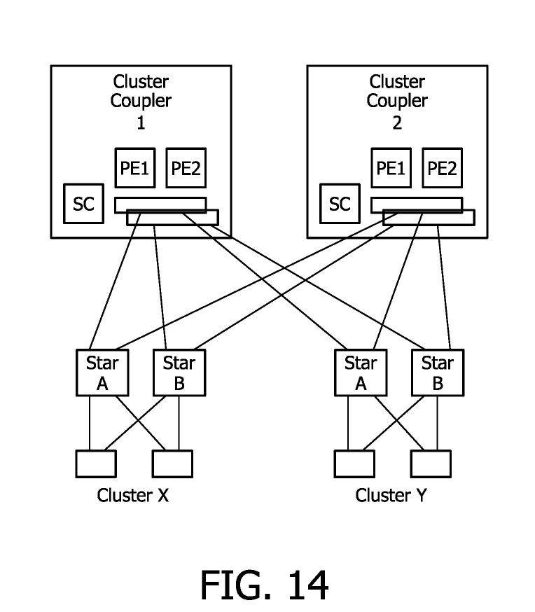

FIG. 14 a further embodiment for connecting cluster couplers according the FIG. 12.

FIG. 1 illustrates a network according to the invention. A cluster coupler 10 is connected to a plurality of clusters A, B, X. The clusters have various topologies. Cluster A has a passive bus construction. In cluster B the nodes (not illustrated) are coupled via an active star coupler, wherein the nodes are connected directly to the star coupler. In cluster X also an active star coupler is used for coupling the nodes, but in the construction of cluster X sub nets of nodes coupled via a passive bus are coupled to the star coupler. An active star coupler connecting the nodes in a cluster serves to improve the signal quality on the communication line, compared to the situation where nodes are connected via a passive bus. An active star coupler allows connecting more nodes in a single cluster than a passive bus. It further offers the possibility to disconnect malfunctioning nodes from the cluster in order to limit the propagation of faults through the cluster. A conventional star coupler works on physical level forwarding data from one selected input port to all output ports at a time. On protocol level, it does not show a difference between a bus and a star topology.

In general, no restriction is made in respect to the topology within a cluster. The sole restrictions or prerequisites are that the same time triggered protocol needs to be used within the clusters A, B, X. Further, the cycle length, time slot length and frame length need to be compatible to each other. Based on the requirements a synchronization between the clusters maybe realized.

With reference to FIG. 1b, a node 11 used in such cluster is described in more detail. A typical fault-tolerant time-triggered network consists of two or more communication channels Channel A, B, to which nodes 11 are connected. Each of those nodes 11 consists of a bus driver 17, a communication controller 15 and eventually a bus guardian device 14 for each bus driver 17 and an application host 13. The bus driver 17 transmits the bits and bytes that the communication controller 15 provides onto its connected channels and in turn provides the communication controller 15 with the information it receives from the channel Channel A, B. The communication controller 15 is connected to both channels and delivers relevant data to the application host 13 and receives data from it that it in turn assembles to frames and delivers to the bus driver 17. For this invention, the communication controller 15 containing the protocol engine is of relevance. The bus driver 17, the bus guardian 14 and the application host 13 are basically only listed to provide a better overview, in which context the invention might be used. The invention is not limited or restricted by the presence or absence of those devices.

The communication controller 15 contains a so-called protocol engine 12, which provides a node 11 with the facilities for the layer-2 access protocol. Most relevant for this invention is the facility to access the medium with a pre-determined TDMA scheme or cluster communication schedule. The communication schedule for each node 11 inside a cluster have to be configured such that no conflict between the nodes 11 occurs when transmitting data on the network. The bus guardian 14 is a device with an independent set of configuration data (cluster communication schedule, or node communication schedule) that enables the transmission on the bus only during those time slots, which are specified by the node or cluster communication schedule. The application host 13 contains the data source and sink and is generally not concerned with the protocol activity. Only decisions that the communication controller 15 cannot do alone are made by the application host 13.

Synchronization between the nodes 11 is a pre-requisite to enable time-triggered TDMA based access to the network. Every node 11 has its own clock, for which the time base can differ from the other nodes n, although they are originally intended to be equal, caused by temperature and voltage fluctuations and production tolerance.

The communication controller 15 includes a synchronization mechanism wherein nodes 11 within the cluster listen to their attached channels and can adapt to, or influence a common clock rate and offset.

Network startup in a single cluster is handled by so called cold-starting nodes, wherein one initiates the communication cycles in a cluster and others respond. This node is selected either by configuration or by some algorithm, that determines which of several potential nodes performs the startup. This algorithm generally consists of transmitting frames or similar constructs over the attached channels, whenever no existing cluster communication schedule could be detected. The communication controller 15 of a cold-starting node thereby has to listen to all attached channels and has to transmit its startup data on all attached potentially redundant channels at the same time. There is only one single control logic for the startup inside the communication controller 15 for all attached channels. Each node listens to its attached channels. If it receives specific frames or similar constructs indicating a startup it will adopt the timing scheme from the observed communication and integrate into the system.

A bus guardian (not illustrated) may be added to such a cluster coupler for each cluster. This bus guardian is preconfigured with information about the communication schedule of its cluster with respect to which of its nodes may transmit data to the other nodes during which time slot of the cluster communication schedule. The bus guardian can also contain logic to determine the cluster communication schedule from information received from its nodes. This normally is a protocol engine with reduced functionality in some respects and added functionality with respect to protecting against different types of faults (e.g. protection against illicit startup attempts from nodes that cannot do so, protection against transmissions longer than anything possibly legal, etc.).

Referring to FIG. 2, a cluster coupler 10 according to the invention is illustrated. The cluster coupler 10 includes communication controller per cluster. A communication controller includes a protocol engine and if a host is connected a controller host interface. By using the controller host interface a host may decide which protocol engine should communicate with the host. Due to simplicity only the protocol engines 12 are illustrated in FIG. 2. It is illustrates how the cluster coupler 10 is connected to several communication clusters A, B, X, each cluster is served by a standard protocol engine 12. For each cluster A, B, X, the cluster coupler 10 contains one protocol engine 12, in the following named as PE. These PEs 12 can be used for different purposes, e.g. to connect an application host or a router to the (different) network clusters (not illustrated). The PEs 12 and the clusters A, B, X are connected to a buffer-less switch 20, which is also known as cross connect or matrix switch 20. The PE 12 contains the normal protocol knowledge about startup, cluster communication schedule, media access, etc. The PE 12 has multiple inputs and outputs of which only two are depicted. The RxD pin represents the receive path while the TxD pin represents the transmit path. Generally, but not exclusively, both are serial interfaces toggling between a “0” and a “1” state. For the FlexRay protocol the transmit path has an additional ‘enable’ pin needed for attaching three-state physical layers (not illustrated).

The switch 20 is primarily intended to selectively forward data between the PEs 12 and the clusters A, B, X and between the clusters A, B, X, but can also be utilized to achieve the obligatory synchronization between the clusters A, B, X by connecting the PEs of the clusters in the cluster coupler to each other. A switch control unit 21 configures the switch 20 based on the control information received from the PEs 12. The switch control unit 21 assures that the switch 20 transports the data according to the needs. The switch control unit 21 is responsible for the configuration of the switch 20 to determine which input ports of the switch 20 are connected to which output ports of the switch 20 at which point in time. The switch control unit 21 receives configuration indications from the PEs and transforms them into appropriate data to be loaded into the configuration registers 31 of the switch 20. It can be implemented with straightforward combinatorial logic that follows the functionality as described in the invention.

The switch 20 can be configured to exchange data between each PE 12 and its associated cluster (default mode), between clusters (forwarding mode) and between PEs (synchronization mode). To perform its task the switch control unit 21 receives control information from each of the PEs 12, wherein each PE 12 indicates when it transmits data, what type of data it transmits (e.g. sync frame) and when it receives data. Additionally, a PE 12 indicates when it allows the switch to forward data from another cluster.

The switch control unit 21 not only configures the switch 20, but can additionally also guard each bus driver (not illustrated) in the transmit path towards the cluster.

In the following the normal operation of the cluster coupler will be described in more detail. As mentioned, each PE 12 generates control information to be used by the switch control unit 21. For the exchange of data in normal operation, it is assumed that the clusters A, B, X are synchronized to each other and that each PE 12 contains a protocol engine communication schedule with the information when it transmits and when it receives and when it is idle. In the latter case the PE still watches the activity on the network, but will not copy the data for further usage. So for basic operation on its own cluster a PE 12 has to indicate the switch control unit 21 in which direction the switch 20 has to forward the data: from PE to the cluster or from the cluster to the PE.

By these two conditions, each PE indicates to the switch control unit 21 how to configure the switch 20 to establish the data transfer between the PE 12 and its cluster A, B, X in a certain time slot.

PE-Rx—the PE receives data from its own cluster

PE-Tx—the PE transmits data to its own cluster

For the purpose of this invention, the information in the communication schedule hold by the PE 12 is extended such that it can be applied for forwarding data between clusters directly. In the communication schedule of a PE 12, additionally information indicates at which cluster the data finds its origin. It is only allowed to forward data from another cluster when no node within the cluster itself is scheduled for transmission. The communication schedule handled by the PE therefore is configured in a way that it not only prevent conflicts between its own transmission and that of the other nodes in the cluster, but also between its forwarding schedule and the other nodes in the cluster. When applying this extension, each PE provides the switch control unit 21 with the following information.

PE-nr—another PE in the cluster coupler 10 is chosen as transmission source for the cluster

CL-nr—another cluster is chosen as transmission source for the cluster

Now the startup and synchronization of the clusters is explained. To ensure a good cooperation between the PEs 12 and the switch 20 in normal operation mode, the clusters A, B, X must be tightly synchronized to each other, both in rate and in offset. The cluster coupler 10, as central element connecting the clusters, is a good node to arrange the synchronization between the clusters. Because the cluster coupler in this invention already has additional facilities in the form of the switch 20 and the switch control unit 21, it is most useful to utilize them for the synchronization of the clusters as well. Assumed that each PE 12 provides the switch control unit 21 with information when it transmits startup and synchronization relevant data, the switch 20 can forward this data also to the other clusters. It thereby can support different cluster synchronization mechanisms, for example one whereby the PEs 12 within the coupler take the lead or one whereby a single master takes the lead. For this purpose the PE provides the Switch control unit 21 with the following information:

PE-Tx-sync—the PE has startup and/or synchronization information that needs to be distributed to all clusters. By receiving such information in the switch control unit 21 the switch 20 maybe controlled in that way that this startup and/or synchronization information is transferred to all clusters.

If multiple PEs within the cluster coupler want to transmit startup data at the same time, a conflict can occur. In this case the switch control unit 21 configures the switch 20 such that only for one of the PEs, the startup information is distributed. The PE of which the startup data is distributed to the clusters takes the lead in the startup procedure. In normal operation mode, the configuration of the PEs and the nodes in the clusters should ensure that no conflict occurs for the transmission of synchronization data from a single PE to multiple clusters. For implementation simplification, this mechanism can be restricted, e.g. by allowing only a single PE in the cluster coupler to distribute its startup and synchronization information.

Now the fault protection mechanism is described. The PE that is assigned to a cluster primarily controls the access and timing via the switch control unit 21 towards the cluster. It watches the incoming data and determines the periods at which the TxD signal is driven on the bus. In case a PE detects a data unit on the bus in its cluster that does not fit into the communication schedule, or has a wrong timing, it can block the data unit originated from the corresponding node to prevent propagation of the fault. In this case the PE indicates the switch control unit 21 that it should not use its cluster as a source for forwarding during this time. This can also be applied in case the PE does not expect any data relevant for forwarding. For this purpose the PE provides the switch control unit 21 with the following information:

PE-blocksrc—the PE indicates that the switch 20 should not forward the data from its associated cluster to the other clusters.

In case a PE detects a data unit forwarded from another cluster that does not fit into its communication schedule or has a wrong timing, it can block the data unit originated from the corresponding node to prevent propagation of the fault. In this case the PE indicates the switch control unit 21, that it should not use its cluster as destination for forwarding during this time. For this purpose the PE provides the switch control unit 21 with the following information:

PE-blockdest—the PE indicates that the switch 20 should not forward the data from another cluster to its associated cluster.

When a bus guardian is attached to a cluster to watch the activities on the cluster, it can block the transmission of data from the coupler towards the cluster coupler to prevent propagation of the fault. Such a bus-guardian can also block data from this cluster to be forwarded the other clusters. In this case the bus guardian, in the following BG, indicates the switch control unit 21 that it should not use its cluster as a source for forwarding during this time. For this purpose a BG provides the switch control unit 21 with the following information

BG-blocksrc—the BG indicates that the switch should not forward the data from its associated cluster to the other clusters.

This requires that the BG of the cluster is directly connected to the switch control unit 21.

In the following the construction of a cross-point matrix is discussed in more detail. FIG. 3 indicates a possible realization of the switch 20 by the usage of a cross-point matrix. The cross-point matrix is configured per output port. For each output port, a configuration register 31 determines to which input port the output port is connected. Writing a new input port number into the configuration register 31 changes the connection for the corresponding output port at the next time slot for which the timing is determined by a synchronization signal. The input ports and output ports of the cross-point matrix are connected to the appropriated PEs, PE-A, PE-B, PE-X and cluster ports CL-A, CL-B, CL-X. The sync signals SYNC PE-A, SYNC PE-B, SYNC PE-X are connected to the appropriated PEs. The configuration interface CONFIG is connected to the switch control unit 21.

In respect to FIGS. 4a, 4b-11a, 11b different switch configurations are demonstrated. The following demonstrates how the switch control unit 21 configures the switch 20 based on information received from the PEs.

When the switch control unit 21 receives the information PE-Rx from the PE, then the PE indicates that it receives data from its own cluster. Thus, the switch control unit 21 connects the RxD of the PE to its associated cluster. FIG. 4a shows the situation in the cluster coupler 10 where all PEs are connected for reception of data from their own cluster. This situation is also the default mode of the switch 20. FIG. 4b illustrates the respective connections within the switch set by the switch control unit 21. A cross means a connection is active. Thus, the cluster A is connected to its protocol engine PE-A. The cluster B is connected to its protocol engine PE-B and the cluster X is connected to its protocol engine PE-X.

When the switch control unit 21 receives the information PE-Tx from the PE-A, then the PE-A indicates that it wants to transmit data to its own cluster A. The other PE-B, PE-X signal further the PE-Rx command to the switch control unit 21. Thus, the switch control unit 21 connects the TxD of the PE-A to its associated cluster A, wherein the RxD of PE-B and PE-X are connected to the respective clusters B, X. This situation is illustrated in FIG. 5a. Additionally, the dotted cross in FIG. 5b indicates that the transmitted data is fed back into PE-A.

A further situation is illustrated in FIGS. 6a and 6b. Therein, the switch control unit receives the PE-nr command from a PE indicated that another PE in the cluster coupler is chosen as transmission source for the cluster. Thus, the switch control unit 21 configures the switch 20 such that it forwards the data from PE-A. FIG. 6a illustrates the situation where PE-B has chosen PE-A (PE-nr=PE-A) to transmit on its cluster B. Further, PE-A has indicated to transmit data to its own cluster by use of the PE-Tx command. Further, the data transmitted to cluster B is fed back into PE-B, either indirectly (as shown) via the cluster or directly (not shown) via the switch 20.

FIGS. 7a and 7b illustrate that cluster A is chosen as transmission source for the cluster B. The switch control unit 21 receives the CL-nr (nr=A) command from a PE-B. Then the switch control unit 21 configures the switch 20 such that it forwards the data from the cluster A to cluster B. FIG. 7b shows this situation where data received from cluster A is forwarded to cluster B. Optionally, the data is fed back into PE-B, either indirectly via the external bus from the cluster B or directly via the switch 20 (not illustrated).

When the switch control unit receives a PE-Tx-sync signal the PE indicates that there are startup and/or synchronization data that needs to be distributed to all clusters. FIG. 8a illustrates the situation where the startup and synchronization data is distributed from PE-A to all other clusters A, B, and X. The transferring of the startup and synchronization data to PE-A, PE-B and PE-X can be done directly as shown in the FIG. 8a, but could also be realized via feedback of the data from the cluster. As indicated in FIG. 8b the input of PE-A is connected to the outputs of PE-B, PE-X and CL-A, CL-B and CL-X.

By indicating the PE-blocksrc command the PE indicates that the switch 20 should not forward the data from its associated cluster to the other clusters. FIGS. 9a and 9b show the situation, wherein PE-A has detected wrong behavior of a node in its cluster A. Therefore, the switch control unit 21 configures the switch 20 such that the data from cluster A is not forwarded towards the other clusters B. X. This can also be realized by letting the switch control unit 21 disable all bus drivers (FIG. 11a) to which this data is forwarded at the appropriate time. This requires a connection from the switch control unit 21 to the bus drivers (not illustrated).

When receiving the PE-blockdest signal the PE-B indicates that the switch 20 should not forward the data from cluster A to its associated cluster B. FIG. 10a and 10b represent the situation where PE-B has detected a wrong behavior of a node in cluster A. The switch control unit 21 configures the switch 20 such that the data is not forwarded towards cluster B. This can also be realized by letting PE-B or the switch control unit 21 disable the bus driver towards at the appropriate time. As mentioned above this requires a connection from the PE to the bus driver or a connection from the switch control unit 21 to the bus drivers (both not illustrated)

FIG. 11a illustrates a cluster coupler having a bus guardian BG connected to each cluster A, B, X. The bus guardians BG-A, BG-B, BG-X are connected to the switch control unit. Further, the bus guardians BG are coupled respectively to the bus drivers 22 in the transmitting paths TxD-A, TxD-B, TxD-X. The signal BG-blocksrc indicates that the BG indicates that the switch 20 should not forward data from its associated cluster to the other clusters. FIG. 11a shows the situation where BG-A has detected a wrong behavior of PE-A. Then, the switch control unit 21 configures the switch 20 such that the data is not forwarded towards the other clusters. This could also be realized by letting the switch control unit 21 disable all bus drivers 22 to which this data is forwarded at the appropriate time.

In the preceding figures, the cluster coupler 10 is connected to a single channel for each cluster. The invention is however not restricted to single channel systems. Multiple channels per cluster can be supported. If the cluster coupler 10 is connected to multiple channels and each channel in a cluster is enumerated by an index (e.g. channel 1, 2, . . . x), a separate switch inside the cluster coupler connects each set of channels with the same index to each other and to the protocol engine inside the coupler. FIG. 12 shows an example of a cluster coupler connecting clusters A, B, X with dual channels.

A further aspect of the invention is the assuring of redundancy within the network. To prevent a single point of failure of the cluster coupler, it is preferred that multiple cluster couplers are connected to the clusters. In this case these cluster couplers must share at least a channel in one of the clusters to be able to synchronize to each other. The cluster couplers preferably share multiple channels, for those clusters containing multiple channels, to provide redundant inter-cluster synchronization.

If two, or more cluster couplers are redundantly present, other nodes in the clusters are not needed for the startup procedure. In this case, it is even not preferred that other nodes participate in the startup procedure to prevent inconsistency of startup procedure. It is better when the PEs in the redundant cluster couplers startup first whereby the other nodes follow.

In normal operation, those PEs of redundant cluster couplers that are associated to the same channel need to have different transmission schedules. One possibility is to let one of the PEs, forward all data that need to be forwarded to the associated channel and let the other PEs connected to the same channel, be hot standby to take over the forwarding of the data in case the other PEs fail. Another possibility is to let each of the PEs connected to the same channel forward part of the received data. It is hereby assumed that a conventional node is able to transmit redundant data, by transmitting it on multiple channels, and/or by transmitting it in multiple slots in the same channel.

An example of redundant couplers connecting two clusters is shown in FIGS. 13 and 14. Two redundant cluster couplers: coupler 1 and coupler 2 connect the clusters X and Y, each having two channels A and B. The connection of the nodes to a channel can be realized with passive bus as shown in FIG. 13 or with an active star as shown in FIG. 14.

One option is that coupler 1 forwards data between channel A of cluster X and channel A of cluster Y and ditto for channels B of cluster X and cluster Y. Coupler 2 is hot standby and configured identical to coupler 1.

A second option is that coupler 1 forwards part of the data between channel A of cluster X and channel A of cluster Y and coupler 2 forwards the other part of the data between channel A of cluster X and channel A of cluster Y, ditto for channels B of cluster X and Y.

A third option is that coupler 1 forwards data between channel A of cluster X and channel A of cluster Y and coupler 2 forwards data between channel B of cluster X and channel B of cluster Y.

By providing a cluster coupler having a switch 20 which is controlled based on information received from protocol engines of the connected clusters it is possible to forward data on a time slot basis between connected cluster alone, between protocol engines of the cluster coupler and between clusters and protocol engines without needing any buffer for storing the data. Additionally, the fault protection between the clusters is increased and the synchronization of the clusters maybe realized very easy by use of the intelligent switchable switch 20 without imposing any delay during forwarding the data.

1. Cluster coupler in a network operating on a time triggered protocol using time slots, wherein the cluster coupler is coupled to at least two clusters, a cluster includes at least one node, wherein the same protocol is used within the clusters, the cluster coupler comprises:
as many protocol engines as clusters are connected,
a switch,
a switch control unit; wherein a protocol engine is transmitting and receiving data in time slots from the cluster and generating control information based on the cluster communication schedule of the connected cluster for configuring the switch.

2. Cluster coupler as claimed in claim 1, wherein the switch is forwarding data between a cluster and its protocol engine, forwarding data between clusters and forwarding data between protocol engines.

3. Cluster coupler as claimed in claim 1, wherein the switch includes a plurality of input ports and output ports in matrix form, wherein a configuration register is assigned to each output port for determining to which input port the output port is connected.

4. Cluster coupler as claimed in claim 1, wherein a protocol engine includes knowledge about startup of the connected cluster, the cluster communication schedule and controls the media access.

5. Cluster coupler as claimed in claim 1, wherein the protocol engines provide the control information to the switch control unit, wherein the switch control unit is configuring the switch to determine which input port of the switch is connected to which output port of the switch at which point of time.

6. Cluster coupler as claimed in claim 1, wherein the control information includes when a protocol engine transmits or receives data and what kind of data are transmitted or received and when forwarding of data to the assigned cluster of the protocol engine is allowed.

7. Cluster coupler as claimed in claim 1, wherein the switch control unit is guarding a bus driver in the transmitting path to the clusters.

8. Cluster coupler as claimed in claim 1, wherein each cluster includes a cluster bus guardian guarding the protocol engine of the connected cluster for blocking in case of an error data received from other clusters or the transmission of outgoing data to other clusters, wherein the cluster bus guardian includes a cluster communication schedule, indicating which node of a cluster may transmit at which point in time.

9. Cluster coupler as claimed in claim 1, wherein the cluster coupler is synchronizing the connected clusters by using the control information provided by each protocol engine to forward other clusters respective startup and synchronization data.

10. Network having a plurality of clusters, wherein each cluster includes a plurality of nodes, the clusters operate on the same time triggered protocol and are connected via a cluster coupler as claimed in claim 1.

11. Method for communicating in a network between different clusters using a time triggered protocol on time slot basis, wherein the network includes a cluster coupler connected to at least two cluster, the cluster coupler includes a switch, the method comprises the following steps:
the protocol engines provide synchronization to and between the clusters and based on their communication schedules provide control and/or synchronization information to the switch control unit which translates these information into a switch configuration to connect input ports to output ports of the switch.
